(19) United States
(12) Patent Application Publication
(10) Pub. No.: US 2020/0074301 A1
(43) Pub. Date: Mar. 5, 2020

(54) END-TO-END STRUCTURE-AWARE CONVOLUTIONAL NETWORKS FOR KNOWLEDGE BASE COMPLETION

(71) Applicants: Beijing Jingdong Shangke Information Technology Co., Ltd., Beijing (CN); JD.com American Technologies Corporation, Mountain View, CA (US)

(72) Inventors: Chao Shang, Mountain View, CA (US); Yun Tang, Mountain View, CA (US); Jing Huang, Mountain View, CA (US); Xiaodong He, Beijing (CN); Bowen Zhou, Beijing (CN)

(21) Appl. No.: 16/542,403

(22) Filed: Aug. 16, 2019

Related U.S. Application Data
(60) Provisional application No. 62/726,962, filed on Sep. 4, 2018.

(51) Int. Cl. G06N 3/08; G06N 5/02

(52) U.S. Cl. CPC G06N 3/08; G06N 5/02

(57) ABSTRACT

A method for knowledge base completion includes encoding a knowledge base comprising entities and relations between the entities into embeddings for the entities and embeddings for the relations. The embeddings for the entities are encoded based on a Graph Convolutional Network (GCN) with different weights for at least some different types of the relations, which GCN is called a Weighted GCN (WGCN). The method further includes decoding the embeddings by a convolutional network for relation prediction. The convolutional network is configured to apply one dimensional (1D) convolutional filters on the embeddings, which convolutional network is called Conv-TransE. The method further includes at least partially complete the knowledge base based on the relation prediction.

### CROSS-REFERENCE TO RELATED APPLICATIONS

This application claims priority to and the benefit of, pursuant to 35 U.S.C. § 119(e), U.S. provisional patent application Ser. No. 62/726,962, filed Sep. 4, 2018, which is incorporated herein in its entirety by reference.

Some references, which may include patents, patent applications and various publications, are cited and discussed in the description of this invention. The citation and/or discussion of such references is provided merely to clarify the description of the present invention and is not an admission that any such reference is “prior art” to the invention described herein. All references cited and discussed in this specification are incorporated herein by reference in their entireties and to the same extent as if each reference was individually incorporated by reference.

### FIELD

The present disclosure relates generally to knowledge base (KB), and more specifically related to systems and methods for completing KB using end-to-end structure-aware convolutional networks (SACNs).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Over the recent years large-scale knowledge bases (KBs), such as Freebase, DBpedia, NELL and YAGO3, have been built to store structured information about common facts. KBs are multi-relational graphs whose nodes represent entities and edges represent relations between entities. The relations are organized in the forms of (s, r, o) triplets (e.g. entity or subject s=Abraham Lincoln, relation r=DateOfBirth, entity or object o=02-12-1809). These KBs are extensively used for web search, recommendation, question answering, or the like. Although these KBs have already contained millions of entities and triplets, they are far from complete compared to existing facts and newly added knowledge of the real world. Therefore, knowledge base completion has been actively researched in order to predict new triplets based on existing ones and thus further expand KBs.

One of the recent active research areas for knowledge base completion is knowledge graph embedding: it encodes the semantics of entities and relations in a continuous low-dimensional vector space (called embeddings). These embeddings are then used for new relation predictions. Started from a simple and effective approach called TransE, many knowledge graph embedding methods have been proposed, such as TransH, TransR, DistMult, TransD, ComplEx, STransE. Many surveys give details and comparisons of these embedding methods.

The most recent ConvE model used 2D convolution over embeddings and non-linear features of multiple layers, and achieved the state-of-the-art performance on several common benchmark datasets for knowledge graph link prediction. In ConvE, the embeddings of s and r are reshaped and concatenated into an input matrix and fed to the convolution layer. n×n convolutional filters are used to output feature maps that are across different dimensional embedding entries. Thus ConvE does not keep the translational property as TransE which is additive embedding vector operation: eₛ+eᵣ eₒ.

Further, ConvE does not incorporate connectivity structure in the knowledge graph into the embedding space. On the other hand, graph convolutional network (GCN) recently has been an effective tool to create node embedding which aggregate local information in the graph neighborhood for each node. GCN models have additional benefits. They can also leverage attributes associated with the nodes. They can impose the same aggregation scheme when computing the convolution for each node, which can be considered a method of regularization and also improves efficiency.

Therefore, an unaddressed need exists in the art to address the aforementioned deficiencies and inadequacies.

### SUMMARY

In one aspect, the disclosure is directed to a method for knowledge base completion. The method includes:

encoding a knowledge base comprising entities and relations between the entities into embeddings for the entities and embeddings for the relations, wherein the embeddings for the entities are encoded based on a Graph Convolutional Network (GCN) with different weights for at least some different types of the relations, which GCN is called a Weighted GCN (WGCN);

decoding the embeddings by a convolutional network for relation prediction, wherein the convolutional network is configured to apply one dimensional (1D) convolutional filters on the embeddings, which convolutional network is called Conv-TransE; and

at least partially completing the knowledge base based on the relation prediction.

In certain embodiments, the method further includes adaptively learning the weights in the WGCN in a training process.

In certain embodiments, at least some of the entities have respective attributes, and the method further includes processing, in the encoding, the attributes as nodes in the knowledge base like the entities.

In certain embodiments, the embeddings for the relations are encoded based on a one-layer neural network.

In certain embodiments, the respective embeddings for the relations have the same dimension as that of the respective embeddings for the entities.

In certain embodiments, the Conv-TransE is configured to keep the transitional characteristic between the entities and the relations.

In certain embodiments, the decoding includes applying, with respect to one from the embeddings for the entities as a vector and one from the embeddings for the relations as a vector, a kernel separately on the one entity embedding and the one relation embedding for 1D convolution to result in two resultant vectors, and weighted summing up the two resultant vectors.

In certain embodiments, the method further includes padding each of the vectors into a padded version, wherein the convolution is performed on the padded version of the vector.

In certain embodiments, the method further includes adaptively learning the kernel in a training process.

In another aspect, the present disclosure relates to a system for knowledge base completion. The system includes a computing device. The computing device has a processor, a memory, and a storage device storing computer executable code. The computer executable code includes:

an encoder configured to encode a knowledge base comprising entities and relations between the entities into embeddings for the entities and embeddings for the relations, wherein the encoder is configured to encode the embeddings for the entities based on a Graph Convolutional Network (GCN) with different weights for at least some different types of the relations, which GCN is called a Weighted GCN (WGCN); and

a decoder configured to decode the embeddings by a convolutional network for relation prediction, wherein the convolutional network is configured to apply one dimensional (1D) convolutional filters on the embeddings, which convolutional network is called Conv-TransE,

wherein the processor is configured to at least partially complete the knowledge base based on the relation prediction.

In certain embodiments, the encoder is configured to adaptively learn the weights in the WGCN in a training process.

In certain embodiments, at least some of the entities have respective attributes, and the encoder is configured to process the attributes as nodes in the knowledge base like the entities.

In certain embodiments, the encoder is configured to encode the embeddings for the relations based on a one-layer neural network.

In certain embodiments, the encoder is configured to encode the respective embeddings for the relations and the respective embeddings for the entities to have the same dimension.

In certain embodiments, the Conv-TransE is configured to keep the transitional characteristic between the entities and the relations.

In certain embodiments, the decoder is configured to apply, with respect to one from the embeddings for the entities as a vector and one from the embeddings for the relations as a vector, a kernel separately on the one entity embedding and the one relation embedding for 1D convolution to result in two resultant vectors, and to weighted sum up the two resultant vectors.

In certain embodiments, the decoder is further configured to pad each of the vectors into a padded version, wherein the convolution is performed on the padded version of the vector.

In certain embodiments, the decoder is further configured to adaptively learn the kernel in a training process.

In another aspect, the present disclosure relates to a non-transitory computer readable medium storing computer executable code. The computer executable code, when executed at a processor, is configured to:

encode a knowledge base comprising entities and relations between the entities into embeddings for the entities and embeddings for the relations, wherein the embeddings for the entities are encoded based on a Graph Convolutional Network (GCN) with different weights for at least some different types of the relations, which GCN is called a Weighted GCN (WGCN);

decode the embeddings by a convolutional network for relation prediction, wherein the convolutional network is configured to apply one dimensional (1D) convolutional filters on the embeddings, which convolutional network is called Conv-TransE; and

at least partially complete the knowledge base based on the relation prediction.

These and other aspects of the present disclosure will become apparent from the following description of the preferred embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, wherein:

FIG. 1 schematically depicts a system according to certain embodiments of the present disclosure.

FIG. 2 is a very simplified illustration of an example of a KB.

FIG. 3 is a block diagram schematically showing a KB completion arrangement according to certain embodiments of the present disclosure.

FIG. 4 schematically depicts an aggregating operation according to certain embodiments of the present disclosure.

FIG. 5 schematically depicts a single WGCN layer according to certain embodiments of the present disclosure.

FIG. 6 schematically depicts an encoder arrangement including L WGCN layers concatenated according to certain embodiments of the present disclosure.

FIG. 7 schematically depicts a graphic representation of operations performed by a single WGCN layer according to certain embodiments of the present disclosure.

FIG. 8 schematically depicts a decoder arrangement according to certain embodiments of the present disclosure.

FIG. 9 schematically depicts a graphic representation of operations performed by a KB completion arrangement according to certain embodiments of the present disclosure.

FIG. 10A and FIG. 10B show convergence of “Conv-TransE”, “SACN” and “SACN+Attr” models.

FIG. 11 schematically depicts a workflow for knowledge graph completion according to certain embodiments of the present disclosure.

FIG. 12 schematically depicts a computing device according to certain embodiments of the present disclosure.

### DETAILED DESCRIPTION

The present disclosure is more particularly described in the following examples that are intended as illustrative only since numerous modifications and variations therein will be apparent to those skilled in the art. Various embodiments of the disclosure are now described in detail. Referring to the drawings, like numbers, if any, indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present disclosure. Additionally, some terms used in this specification are more specifically defined below.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. It will be appreciated that same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and in no way limits the scope and meaning of the disclosure or of any exemplified term. Likewise, the disclosure is not limited to various embodiments given in this specification.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about”, “substantially” or “approximately” shall generally mean within 20 percent, preferably within 10 percent, and more preferably within 5 percent of a given value or range. Numerical quantities given herein are approximate, meaning that the term “around”, “about”, “substantially”or “approximately” can be inferred if not expressly stated.

As used herein, “plurality” means two or more.

As used herein, the terms “comprising,” “including,” “carrying,” “having,” “containing,” “involving,” and the like are to be understood to be open-ended, i.e., to mean including but not limited to.

As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure. As used herein, the term “and/or” includes any and all combinations of one or more of the associated listed items.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code”, as used herein, may include software, firmware, and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The term “interface”, as used herein, generally refers to a communication tool or means at a point of interaction between components for performing data communication between the components. Generally, an interface may be applicable at the level of both hardware and software, and may be uni-directional or bi-directional interface. Examples of physical hardware interface may include electrical connectors, buses, ports, cables, terminals, and other I/O devices or components. The components in communication with the interface may be, for example, multiple components or peripheral devices of a computer system.

The present disclosure relates to computer systems. As depicted in the drawings, computer components may include physical hardware components, which are shown as solid line blocks, and virtual software components, which are shown as dashed line blocks. One of ordinary skill in the art would appreciate that, unless otherwise indicated, these computer components may be implemented in, but not limited to, the forms of software, firmware or hardware components, or a combination thereof.

The apparatuses, systems and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

The present disclosure will now be described more fully hereinafter with reference to the accompanying drawings, in which embodiments of the present disclosure are shown. This disclosure may, however, be embodied in many different forms and should not be construed as being limited to the embodiments set forth herein; rather, these embodiments are provided so that this disclosure will be thorough and complete, and will fully convey the scope of the present disclosure to those skilled in the art.

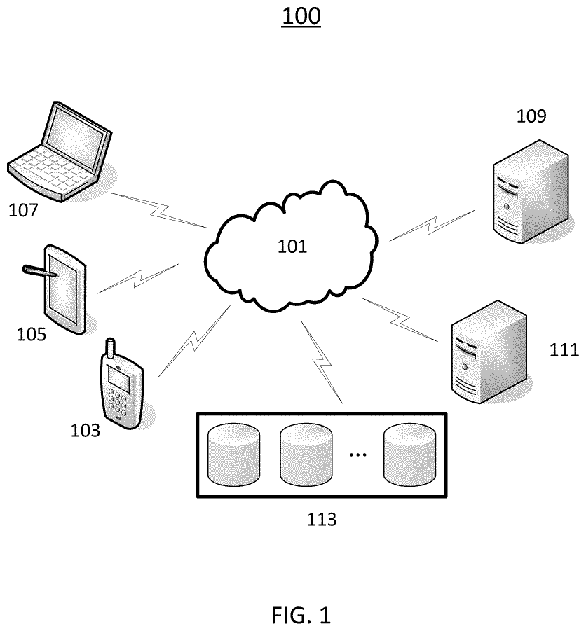

FIG. 1 schematically depicts a system according to certain embodiments of the present disclosure. As shown in FIG. 1, the system 100 includes a network 101, terminal devices 103, 105, 107, servers 109, 111, and databases 113 which are interconnected via the network 101. It is to be noted that the number and arrangement of these components are provided for illustrative purpose only. Other arrangements and numbers of components are possible without departing from the scope of the present disclosure.

The network 101 is a medium to provide communication links between, e.g., the terminal devices 103, 105, 107, the servers 109, 111, and the databases 113. In some embodiments, the network 101 may include wired or wireless communication links, fiber, cable, or the like. In some embodiments, the network 101 may include at least one of Internet, Local Area Network (LAN), Wide Area Network (WAN), or cellular telecommunications network. The network 101 may be a homogenous one or a heterogeneous one.

The terminal devices 103, 105, 107 may be used by their respective users to interact with each other, and/or with the servers 109, 111, to, for example, receive/send information therefrom/thereto. In certain embodiments, at least some of the terminal devices 103, 105, 107 may have various applications (APPs), such as, on-line shopping APP, web browser APP, search engine APP, Instant Messenger (IM) App, e-mail APP, and social networking APP, installed thereon. In some embodiments, the terminal devices 103, 105, 107 may include electronic devices having an Input/Output (I/O) device. The I/O device may include an input device such as keyboard or keypad, an output device such as a display or a speaker, and/or an integrated input and output device such as a touch screen. Such electronic devices may include, but not limited to, smart phone, tablet computer, laptop computer, or desktop computer.

The servers 109, 111 are servers to provide various services. Each of the servers 109, 111 may be a general-purpose computer, a mainframe computer, a distributed computing platform, or any combination thereof. In certain embodiments, any of the servers 109, 111 may be a standalone computing system or apparatus, or it may be a part of or a subsystem of a larger system. In certain embodiments, any of the servers 109, 111 may be implemented by the distributed technique, the cloud technique, or the like. Therefore, at least one of the servers 109, 111 is not limited to the illustrated single one integrated entity, but may include entities (for example, computing platforms, storage devices, or the like) which are interconnected (over, e.g., the network 101) and thus cooperate with each other to perform some functions, for example, those functions to be described hereinafter.

In certain embodiments, one of the servers, for example, the server 109 may include a web server supporting web-related services such as web surfing. The web server 109 may include one or more computer systems configured to host and/or serve documents such as websites and media files over the network 101 to one or more of the terminal devices 103, 105, 107. In some embodiments, the web server 109 may receive one or more search queries from any of the terminal devices 103, 105, 107 through the network 101. The web server 109 may include, or may be connected to, the databases 113 and a search engine (not shown). The web server 109 may respond to the query by locating and retrieving data from the databases 113, generating search results, and transmitting the search results to the terminal device which submitted the query through the network 101.

In certain embodiments, one of the servers, for example, the server 111, may include a knowledge server supporting knowledge base (KB) related services such as KB establishment, KB maintenance, KB completion or the like. In certain embodiments, the knowledge server 111 may implement or provide one or more engines for building and updating KBs. The knowledge server 111 may include hardware components, software components, or a combination thereof to perform data mining, KB creation and updating, KB completion, or other KB related functionalities. For example, the knowledge server 111 may include one or more hardware and/or software components configured to analyze documents stored in the databases 113 to mine entities and entity relations between these entities from these documents, and generate one or more KBs based on the entities and the entity relations. The components of the knowledge server 111 may be special-purpose ones which are specialized for their respective functionalities, or general ones which are configured by some codes or programs to perform desired functionalities.

The databases 113 are configured to store various kinds of data. The data stored in the databases 113 may be received from one or more of the terminal devices 103, 105, 107, the servers 109, 111, or any other data sources (e.g., data storage media, user inputs, etc.). The stored data may take various forms, including, but not limited to, texts, images, video files, audio files, web pages, or the like. In some embodiments, the databases 113 may store one or more KBs, which can be built and/or updated by the knowledge server 111.

The databases 113 may include one or more logically and/or physically separate databases as illustrated. At least some of these databases can be interconnected through, e.g., the network 101. The databases each may be implemented using one or more computer-readable storage media, a storage area network, or the like. Further, the databases 113 may be maintained and queried using various types of database techniques, such as, SQL, MySQL, DB2, or the like.

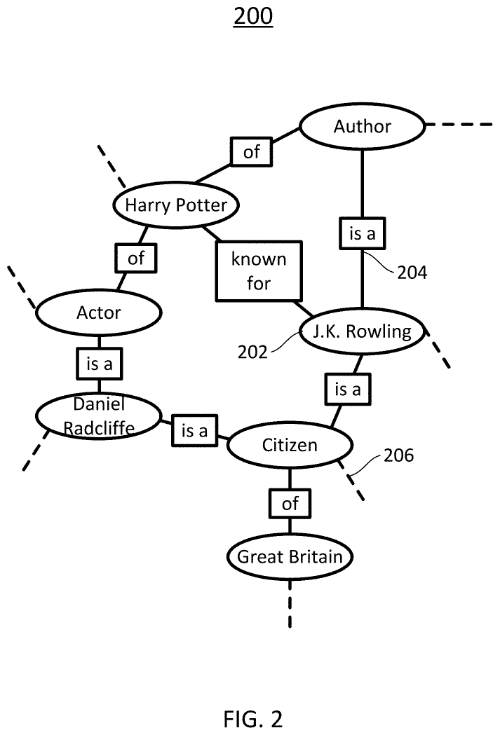

FIG. 2 is a very simplified illustration of an example of a KB. As shown in FIG. 2, the KB 200 may comprise a plurality of entities (represented by bubbles) 202 and relations 204 between the respective entities 202. The KB 200 may be stored in the databases 113 as shown in FIG. 1. The KB 200 is also called a knowledge graph, where the entities 202 constitute nodes of the graph and the relations 204 constitute edges of the graph. As described in the background, the relations can be organized in the forms of (s, r, o) triplets. Known relations between entities are represented by solid lines 204. As shown in FIG. 2, the KB 200 may have a numerous of known relations 204, yet may not know some relations between some entities. Those unknown relations are indicated by dashed lines 206. The technology described herein can achieve completion of the KB 200 to some extent by predicting at least some unknown relations (relation or link prediction).

The link prediction problem can be formalized as a point-wise learning to rank problem, where the objective is learning a scoring function u. Given an input triple x=(s, r, o), its score ψ(x) ∈R is proportional to the likelihood that the fact encoded by x is true.

Neural link prediction models can be seen as multi-layer neural networks consisting of an encoding component (or “encoder”) and a scoring component (or “decoder”). Given an input triple (s, r, o), the encoding component maps entities s, o to their distributed embedding representations eₛ, eₒ. In the scorning component, the two entity embeddings eₛ and eₒ are scored by the scoring function.

More specifically, the graph representation can be mapped into a (low-dimensional) vector space representation, called “embedding”. Knowledge graph embedding learning has been an active research area with applications directly on knowledge base completion (i.e. link prediction) and relation extractions. TransE started this line of work by projecting both entities and relations into the same embedding vector space, with translational constraint of eₛ+eᵣe₀. The later enhanced KG embedding models such as TransH, TransR, and TransD introduced new representations of relational translation and thus increased model complexity. These models were categorized as translational distance models or additive models, while DistMult, HolE, and ComplEx are multiplicative models, due to the multiplicative score functions used for computing entity-relation-entity triplet likelihood.

The most recent KG embedding models are ConvE and ConvKB. ConvE was the first model using 2D convolutions over embeddings of different embedding dimensions, with the hope of extracting more feature interactions. While ConvKB proposed to replace 2D convolutions in ConvE with 1D convolutions, constraints the convolutions within the same embedding dimensions to keep the translational property of TransE. Although ConvKB was shown to be better than ConvE, the results on two datasets FB15k-237 and WN1 8RR were not consistent. The other major difference of ConvE and ConvKB is on the loss functions used to train the models. ConvE used cross-entropy loss that can be speed up with 1-N scoring in the decoder, while ConvKB used hinge loss that computed from positive examples and sampled negative examples. We propose to take the decoder from ConvE because we can easily integrate the encoder of Graph Convolutional Network (GCN) and decoder of ConvE into one end-to-end training framework, while ConvKB is not suitable for our approach.

The most recent ConvE model used 2D convolution over embeddings and multiple layers of non-linear features, and achieved the state-of-the-art performance on several common benchmark datasets for knowledge graph link prediction. In ConvE, the embeddings of s and r are reshaped and concatenated into an input matrix and fed to the convolution layer. 3×3 convolutional filters in the experiments are used to output feature maps that are across different dimensional embedding entries. Thus ConvE does not keep the translational property as TransE which is additive embedding vector operation: eₛ+eᵣ≈eₒ. Here we propose to remove the reshape step of ConvE and operate 1-D convolutional filters on the same dimensions of s and r. This simplified version of ConvE achieves as good performance as the original ConvE, and has an intuitive interpretation which keeps the global learning metric among the same dimensional entries of an embedding triple (eₛ, eᵣ, eₒ). We term this embedding as Conv-TransE.

These neural embedding models achieved good performance for knowledge base completion in terms of efficiency and scalability. However, these approaches only model relational triplets, while ignoring a large number of attributes associated with graph nodes, for example, ages of people or release region of music. Furthermore, these models do not enforce any large-scale structure in the embedding space, i.e. totally ignore the knowledge graph structure. Our proposed structure-aware convolutional networks (SACN) handle these two problems in an end-to-end training framework, by using a variant of graph convolutional network (GCN) as an encoder, and a variant of ConvE as the decoder.

GCNs were first proposed in which graph convolutional operations were defined in Fourier domain. However, the eigendecomposition of the graph laplacian here causes intense computations. Later, smooth parametric spectral filters were introduced to achieve localization in the spatial domain and the computational efficiency. Recently, these spectral methods were simplified by a first-order approximation of the Chebyshev polynominals. The spatial graph convolutional approaches define convolutions directly on graph, which sum up node features over all spatially close neighbors by using adjacency matrix.

GCN models were mostly criticized for its huge memory requirement to scale to huge graphs. However, a data efficient GCN algorithm called PinSage was developed, which combines efficient random walks and graph convolutions to generate embeddings of nodes that incorporate both graph structure as well as node feature information. The experiments on Pinterest data are by far the largest application of deep graph embeddings to date with 3 billion nodes and 18 billion edges. The success paves the way for a new generation of web-scale recommender systems based on GCNs. Therefore, we believe our proposed model could also take advantage of huge graph structures as well as high efficiency of Conv-TransE.

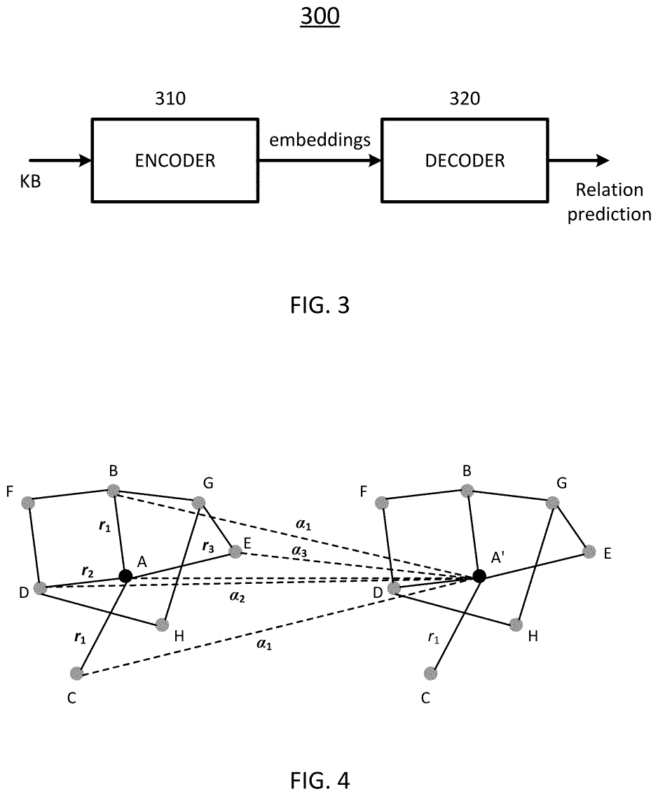

FIG. 3 is a block diagram schematically showing a KB completion arrangement according to certain embodiments of the present disclosure. The blocks shown in FIG.3 may be implemented by hardware modules or software components, or a combination thereof. Therefore, the block diagram shown in FIG. 3 may be a configuration of a hardware apparatus, or a flow of a method executed by, for example, a computing device, or a hybrid thereof. Thus, we refer to the block diagram 300 shown in FIG. 3 as an “arrangement.”

The arrangement 300 comprises an encoder 310 in FIG. 3. The encoder 310 is configured to map or encode an input KB, in the form of knowledge graph, into embeddings (i.e., vectors). Here, we consider an undirected graph G=(V, E), where V is a set of nodes with |V|=N (i.e., the number of the nodes is N), and E⊆V×V is a set of edges with |E|=M (i.e., the number of the edges is M). The knowledge graph can be represented by a node feature matrix (the node feature can be some text or description) and an adjacency matrix A of size N×N, where A_{i,j}=1 if there is an edge from vertex vᵢ to vertex vⱼ, and Aᵢⱼ=0 otherwise. Further, if A_{i,j}=1, we say that vᵢ and vⱼ are adjacent. The knowledge graph may be a multi-relational graph that includes multiple types of relations. According to certain embodiments of the present disclosure, the multi-relational graph can be treated as multiple single-relational subgraphs where each of the subgraphs entails a specific type of relations and has its own adjacency matrix. More specifically, based on the types of the relations, the connectivity structure between the nodes can be different. For example, two nodes may be associated with each other by a first type of relation therebetween, but have no second type of relation therebetween. In other words, these two nodes are connected by an edge representing the first type of relation, but are not connected by an edge representing the second type of relation. That is, these two nodes are adjacent in a subgraph for the first type of relation, but are not adjacent in a subgraph for the second type of relation. Therefore, adjacency matrices for the different subgraphs corresponding to the different types of relations may be different, and thus there can be multiple adjacency matrices corresponding to the respective subgraphs or types of relations.

According to certain embodiments of the present disclosure, the encoder 310 in FIG. 3 is configured with a GCN. The GCN provides a way of learning graph node embedding by utilizing graph connectivity structure. Here, we propose an extension of the conventional GCN by weighing differently at least some of the different types of relations when aggregating. This extension can be called weighted GCN, or WGCN. The WGCN can control the amount of information from neighboring nodes used in aggregation. In other words, the WGCN determines how much weight to give to each of the subgraphs when combining the GCN embeddings. The weights can be adaptively learned during a training process of the WGCN.

FIG. 4 schematically depicts an aggregating operation according to certain embodiments of the present disclosure.

As shown FIG. 4, a simplified graph is illustrated, including nodes A, B, H, and some edges therebetween. In this figure, node A under discussion is shown in black, and other nodes B, . . . , H are shown in gray, only for purpose of clarification. In the example, node A is connected to or adjacent to each of nodes B, C, D, and E. As described above, edges AB, AC, AD, and AE may be different types of relations. In this example, three types of relations are shown for illustrative purpose, including r₁ to which edges AB and AC pertain, r₂ to which edge AD pertains, and r3 to which edge AE pertains. In the aggregating operation, information from nodes B, C, D, and E adjacent to node A (for example, embeddings thereof) are aggregated into node A, which then is indicated as A′. How to incorporate the neighboring information can be specified by a function g, which will be further described hereinafter. The information from the respective adjacent nodes B, C, D and E can be weighted by respective weights α₁, α₂, and α₃ corresponding to relations r₁, r₂, and r₃, respectively.

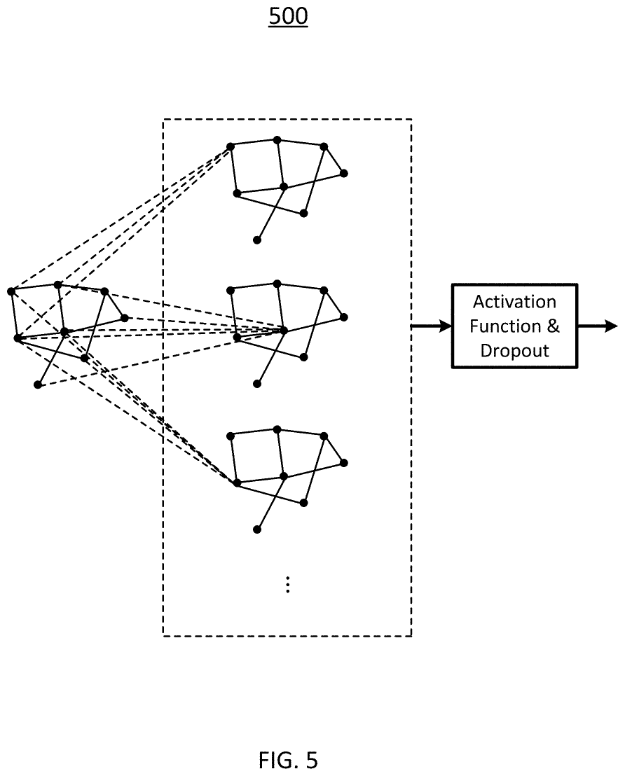

FIG. 5 schematically depicts a single WGCN layer according to certain embodiments of the present disclosure. As shown in FIG. 5, the WGCN layer 500 is configured as a neural network, more specifically, a graph convolutional network in nature, as described above. The WGCN layer 500 may receive embeddings of the KB, especially, embeddings of the nodes, as input. Aggregating operations can be performed as described above with respect to the respective nodes, in which the respective weights corresponding to the respective types of relations are applied. FIG. 5 shows the aggregating operating on 3 nodes (those on the most left side) by dashed lines, for illustrative purpose. The WGCN layer 500 may output optimized embeddings of the respective nodes based on an activation function. According to some embodiments, dropout can be applied to drop out some neurons at a certain probability (dropout rate).

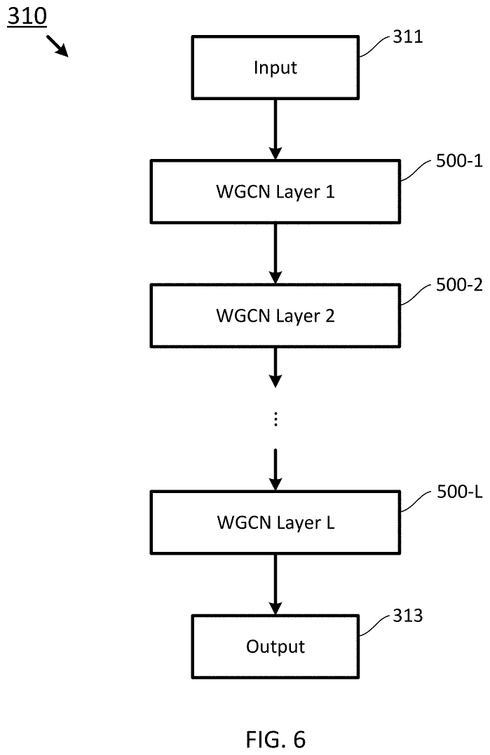

According to certain embodiments of the present disclosure, multiple, for example, 3 or 5, WGCN layers may be stacked to achieve a deep GCN model. FIG. 6 schematically depicts an encoder arrangement including L WGCN layers concatenated according to certain embodiments of the present disclosure.

As shown in FIG. 6, the encoder 310 includes several WGCN layers 500-1, 500-2, . . . , 500-L, each of which can be configured as described above in conjunction with FIG. 5. Input 311 to the encoder 310 may include the embeddings of the KB, especially, the embeddings of the nodes, and output 313 from the encoder 310 may include optimized embeddings.

More specifically, the l-th WGCN layer 500-l takes the output vector of length F^{l} for each node from the previous layer 500-(l−1) as input and generates a new representation comprising F^{l+1} elements. Let hᵢ^{l} represent the input (row) vector of the node vᵢ in the l-th WGCN layer, and thus H^{l} ∈R^{N×R}^{^{l}} be the input matrix for this layer. The initial embedding H¹ is randomly drawn from, e.g., Gaussian. If there are a total of L layers in the encoder 310, the output H^{L+1} of the L-th layer is the final embedding. Because the KB graph is multi-relational, the edges in E have different types. Let the total number of edge types be T. The interaction strength between two adjacent nodes is determined by their relation type and this strength is specified by a parameter {αₜ, 1≤t≤T} for each edge type, which is automatically learned in the neural network.

As described above, each of the WGCN layers 500-1, . . . , 500-L calculates the embedding for each of the nodes. The WGCN layer aggregates the embeddings of neighboring entity nodes as specified in the KB relations. Those neighboring entity nodes are summed up with different weights according to at in this layer to arrive at the actual embedding of the node. The edges of the same type may use the same at. Each of the layers may have its own set of relation weights at, so here we use a superscript to indicate the layer index (at). Hence, the output of the l-th layer for the node vᵢ can be written as follows:

hᵢ^{l+1}=σ(Σ_{j∈N}_{ᵢ}Σₜ₌₁^{T}αₜ^{l}g(hᵢ^{l}, hⱼ^{l})), (1)

where hᵢ^{l} ∈ R^{F}^{^{l}} is the input for node vᵢ, hᵢ^{l+1}∈ R^{F}^{^{l+1}} is the output for node vᵢ, hⱼ^{l} ∈ R^{F}^{^{l}} is the input for node vⱼ and vⱼ is a node in the neighbor Nᵢ of node vⱼ, the function g specifies how to incorporate neighboring information, and the function σ is the activation function. A proper weight α is chose according to the particular relationship between nodes vᵢ and vⱼ. Here, the activation function a is applied component-wisely to its vector argument. Although any g function suitable for KB embedding can be used in conjunction with the proposed framework, the following g function according to certain embodiments is given by way of example:

g(hᵢ^{l}, hⱼ^{l})=hⱼ^{l}W^{l}, (2)

where W^{l} ∈ R^{F}^{×F}^{^{l+1}} is the connection coefficient matrix and used to linearly transform hⱼ^{(l)} ∈ R^{F}^{ⁱ} to hⱼ^{(l+1)} ∈ R^{F}^{ⁱ}⁺¹.

In equation (1), the input vectors of all neighboring nodes are summed up but not the node vᵢ itself, hence self-loops are enforced in the network. For node vᵢ, the propagation process is defined as:

hᵢ^{l+1}=σ(Σ_{j∈N}_{ᵢ}αₜ^{l}hⱼ^{l}W^{l}+hⱼ^{l}W^{l}) (3)

The output of the l-th layer is a node feature matrix: H^{l+1} ∈ R^{N×F}^{^{l+1}}, and hᵢ^{l+1} is the i-th row of H^{l+1}, which represents features of node vᵢ in the (l+1)-th layer.

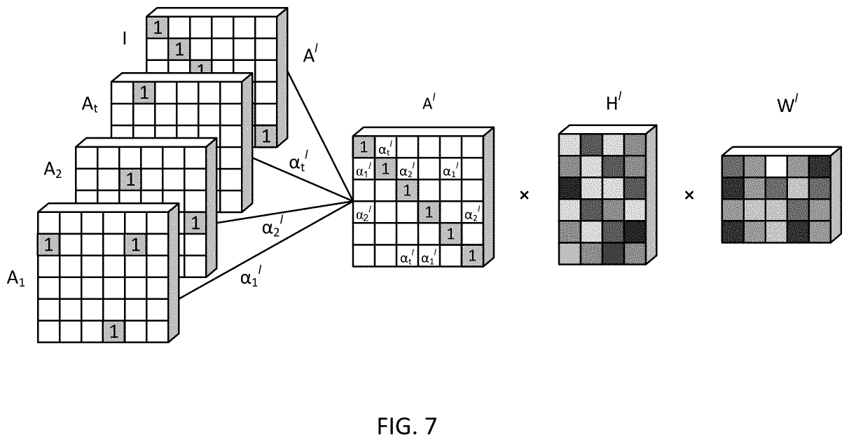

The above process can be organized as a matrix multiplication as shown in FIG. 7 to simultaneously compute embeddings for all the nodes through an adjacency matrix. For each relation (edge) type, an adjacency matrix Aₜ is a binary matrix whose ij-th entry is 1 if an edge connecting nodes vᵢ and vⱼ exists or 0 otherwise. The final adjacency matrix is written as follows:

A^{l}=Σₜ₌₁^{T}(αₜ^{l}Aₜ)+1, (4)

where I is the identity matrix. Basically, the A^{l} is the weighted sum of the adjacency matrices of the subgraphs plus self-connections. In this implementation, we consider all first-order neighbors in the linear transformation as shown in FIG. 6 as follows:

H^{l+1}=σ(A^{l}H^{l}W^{l}). (5)

According to some other embodiments, higher order neighbors can be also considered by multiplying A to itself. Further, at least some nodes of the KB graph generally associated with several attributes, for example, in the form of (entity, relation, attribute) triplets. Accordingly, we have both entity nodes and attribute nodes in the KB. An example of such triplets can be (s=Tom, r=people.person.gender, a=male) where gender is an attribute associated with a person. If we use a vector to represent the node attribute, there can be two problems limiting the use of the vector. First, the number of attributes for each node is commonly small, and the attributes for one node may differ from another node. Hence, the attribute vector will be very sparse. Second, the value of zero in the attribute vector may have ambiguous meanings: the node does not have the specific attribute or the node misses the value for this attribute. The zeros will influence the accuracy of the embedding. Here, we propose a better way to combine the node attributes.

According to certain embodiments, the entity attributes are represented in the knowledge graph by another set of nodes called attribute nodes. Attribute nodes act as the “bridges” to link the related entities. The entity embeddings can be transported over these “bridges” to incorporate the entity's attributes into its embedding. Because these attributes exhibit in triplets, we represent the attributes similarly to the representation of the entity in relation triplets. However, each type of attribute corresponds to a node. For instance, in the above example, gender is represented by a single node rather than two nodes for “male” and “female”. In this way, the WGCN does not only utilize the graph connectivity structure (relations and relation types) in the KB graph but also leverages the node attributes effectively. It is why we name our WGCN method a structure-aware GCN.

According to certain embodiments, the nodes of the KB as well as the relations are encoded into their respective embeddings by the above described WGCN. The relation embedding may have the same dimension as the entity embedding. In other words, the dimension of the relation embedding is equal to F^{L}. Input to the network may be a list of indices. Output from the network, i.e., embedding matrix, may be weights used in that neural network which are updated during the training process of the entire network.

The arrangement 300 further comprises a decoder 320. The decoder 320 is configured to decode the embeddings from the encoder 310 to score a triplet (s, r, o), for link prediction. According to certain embodiments, the decoder 320 is configured based on the ConvE model while keeping the translating characteristic from the TransE model. Therefore, we called it as a Conv-TransE model.

The original TransE model directly learns the embedding vectors eₛ, eᵣ, and eₒ such that eₛ+eᵣ=eₒ if the triplet (s, r, o) is present in the KB without representing the embedding by a neural network. Inspired by the TransE method, we develop the Conv-TransE model as a decoder that performs the same function as the TransE operation but additionally implements the embedding by a convolutional network (which is similar to the ConvE method). Using much simpler convolutional kernels, the Conv-TransE method can achieve at least the same state of the art performance on link prediction as that of ConvE. The convolutional kernels will be described in more detail hereinafter.

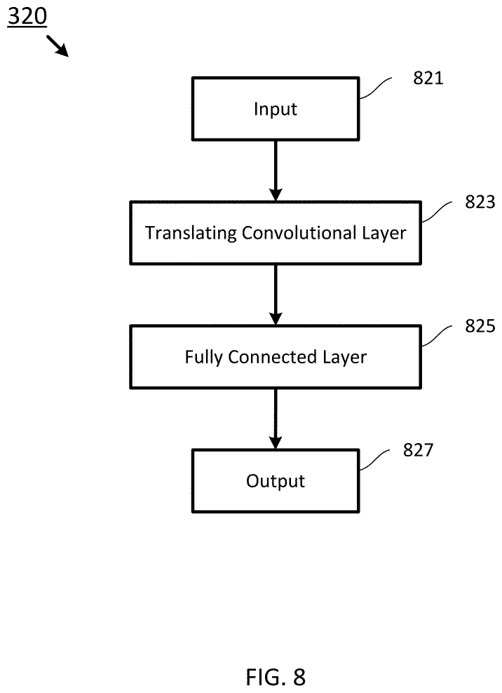

FIG. 8 schematically depicts a decoder arrangement according to certain embodiments of the present disclosure. As shown in FIG. 8, the decoder 320 includes a (translating) convolutional layer 823 and a fully connected layer 825, which is similar to the ConvE model.

Input 821 to the decoder 320 is the output from the encoder 310, including embeddings for the nodes and also embedding for the relations. Those embeddings, if having the same dimension as described above, can be stacked. Thus, for the decoder 320, the input 821 includes two embedding matrices: one R^{N×F}^{^{L}} from the WGCN for all entity nodes and the other R^{M×F}^{^{L}} from the one-layer neural network for all edges.

The translating convolutional layer 823 is configured to perform convolution operations on or apply convolutional filters to the input embeddings. The ConvE model has a reshaping step to reshape each embedding vector into a matrix form, so that a two-dimensional (2D) convolutional filter can be applied. Differently from the ConvE model, the translating convolutional layer 823 removes the reshaping step, while keeping the respective embedding in the vector form, so that a one-dimensional (1D) convolutional filter can be applied to keep the translating characteristic. That's why we call this layer as the “translating” convolutional layer.

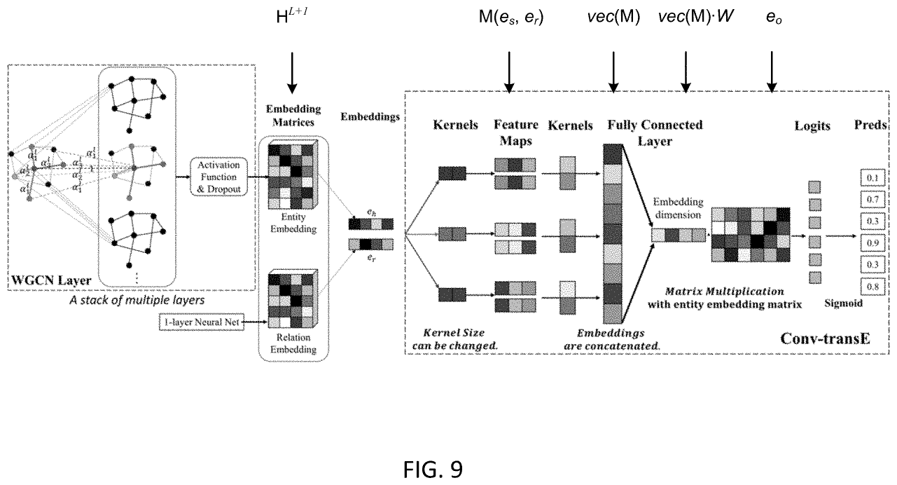

In the convolution operation, the simplest kernel can be a weighted sum of eₛ and eᵣ, which can be regarded as a convolution with a 2×1 (one dimensional) kernel on the matrix that is obtained by stacking eₛ on top of eᵣ. Slightly more complex kernels can also be used. For instance, we can compute a convolution with a 1×3 kernel separately on eₛ and eᵣ, and then weighted sum the two resulting vectors (actually shown in FIG. 9). We experimented with several of such settings in our empirical study.

According to certain embodiments, a mini-batch stochastic training algorithm can be used. In this case, the decoder firstly can perform a look-up operation upon the embedding matrices to retrieve the input eₛ and eᵣ for the triplets in the mini-batch.

More specifically, given C different kernels where the c-th kernel is parameterized by ω_{c}, the convolution in the decoder is computed as follows:

m_{c}(eₛ, eᵣ, n)=Σ_{τ=0}^{K-1}ω_{c}(τ, 0)êₛ(n+τ)+ω_{c}(τ, 1)êᵣ(n+τ), (6)

where K is the kernel width, n indexes the entries in the output vector and n ∈ [0, F^{L}−1], and the kernel parameters ω_{c} are trainable, wherein ω_{c}(τ, 0) represents the kernel parameters for the entity embeddings, and ω_{c}(τ, 1) represents the kernel parameters for the edge embeddings.

In the above equation (6), êₛ and êᵣ ∈ R^{F}^{^{L}}^{+K-1} are padding versions of eₛ and eᵣ, respectively. The padding version is obtained by filling zero-elements preceding and also following eₛ or eᵣ, so that elements of eₛ and eᵣ near to the starting and ending elements can contribute more in the convolution operation. More specifically, the first └(K−1)/2┘ and the last └(K−1)/2┘ elements of êₛ and êᵣ are zeros, other elements of êₛ and êᵣ are copied from eₛ and eᵣ directly, say êₛ(n+└K/2┘)=eₛ(n) and êᵣ(n+└K/2┘)=eᵣ(n). Again, as discussed above, this convolution operation amounts to a weighted sum of eₛ and eᵣ after a 1D convolution. Hence, it preserves the translational property. The output will form a vector M_{c}(eₛ, eᵣ)=[m_{c}(eₛ, eᵣ, 0), . . . , m_{c}(eₛ, eᵣ, F^{L}−1)]. Aligning the output vectors from the convolution with all kernels yields a matrix M (eₛ, eᵣ) ∈ R^{C×F}^{^{L}}, which is called a feature map matrix.

The fully connected layer 825 is configured to reshape the feature map matrix M(eₛ, eᵣ) into a vector vec(M(eₛ, eᵣ)) ∈ r^{CF}^{^{L}}, by, for example, concatenating the output vectors, which is then projected into the embedding dimension, i.e., a F^{L} dimensional space using a linear transformation parameterized by a matrix W ∈ R^{CF}^{^{L}}^{×F}^{^{L}} and matched with an object embedding eₒ by an appropriate distance metric, for example, via an inner product.

Finally, the scoring function is defined as follows:

ψ(eₛ, eₒ)=f(vec(M(eₛ, eᵣ))W)eₒ (7)

where ƒ denotes a non-linear function (implemented by the network). Output 827 from the decoder 320 can be the score for the triplet (s, r, o) or the probability of the fact that entities s and o are associated with each other by the relation r being true.

In the decoder 320, the parameters of the convolutional filters and the matrix W can be independent of the parameters for the entities s and o and the relations r.

During the training process, we apply the logistic sigmoid function a to the score, that is p (eₛ, eᵣ, eₒ)=σ(ψ(eₛ, eₒ)), and minimize the following binary cross-entropy loss:

$$( p , t ) = - \frac{1}{N} {\sum }_{i} ( {t}_{i} \cdot log ( {p}_{i} ) + ( 1 - {t}_{i} ) \cdot log ( 1 - {p}_{i} ) ) , \qquad ( 8 )$$

where t is the label vector with dimension R^{1×1} for 1-1 scorning or R^{1×N} for 1-N scorning, and the elements of vector t are ones for relations that exit or zero otherwise.

In Table 1, we summarize the scoring functions used by several state of the art models. The vector eₛ and eₒ are the subject and object embedding respectively, eᵣ is the relation embedding, ēₛ and ēᵣ denote a 2D reshaping of eₛ and eᵣ, “concat” means concatenates the inputs, and “*” denotes the convolution operator.

TABLE 1
Scorning Function

| Model | Scoring Function ψ(eₛ, eₒ) |
|---|---|
| TransE | ∥eₛ + eᵣ − eₒ∥ₚ |
| DistMult | <eₛ, eᵣ, eₒ> |
| ComplEx | <eₛ, eᵣ, eₒ> |
| ConvE | f (vec (f (concat (ēₛ, ēᵣ) *ω))W) eₒ |
| ConvKB | concat (g([eₛ, eᵣ, eₒ] *ω)) β |
| SACN | f (vec (M (eₛ, eᵣ))W) eₒ |

FIG. 9 schematically depicts a graphic representation of operations performed by the arrangement 300 according to certain embodiments of the present disclosure. As shown in FIG. 9, for the encoder, a stack of multiple WGCN layers builds a deep node embedding model to get the entity/node embedding matrix. Further, the relation/edge embedding matrix is learned by a 1-layer neural network. For the decoder, eₛ and eᵣ are fed into Conv-TransE. Conv-TransE model keeps translational property between entity vector and relation vector by the kernels. The output embeddings are reshaped and projected into a vector, which is matched with eₒ by an inner product. The Sigmoid function is used to get the predictions.

Here, it is to be noted that the convolution as formulated by Equation (6) is shown in FIG. 9 as two separate operations, one for 1D convolution on the respective embeddings eₛ and eᵣ, and the other for weighted sum of the convolution results.

According to the embodiments, the proposed SACN model takes advantage of knowledge graph node connectivity, node attributes and relation types. The learnable weights in WGCN help to collect adaptive amount of information from neighboring graph nodes. The node attributes are added as additional nodes and are easily integrated into the WGCN. In addition, Conv-TransE keeps the transitional characteristic between entities and relations to learn the translating embedding for the task of link prediction.

The proposed SCAN model is tested on some datasets. Here, three benchmark datasets (FB15k-237, WN18RR and FB15k-237-Attr) are utilized to evaluate the performance of link prediction.

FB15k-237 The FB15k-237 dataset contains knowledge base relation triples and textual mentions of Freebase entity pairs. The knowledge base triples are a subset of the FB15K, originally derived from Freebase. The inverse relations are removed in FB15k-237.

WN18RR WN18RR is created from WN18, which is a subset of WordNet. WN18 consists of 18 relations and 40,943 entities. However, many text triples obtained by inverting triples from the training set. Thus WN18RR dataset is created to ensure that the evaluating dataset that doesn't have inverse relation test leakage. WN18RR contains 93,003 triples with 40,943 entities and 11 relations.

Most of previous methods only model the entities and relations, ignoring the abundant entities' attribute information. Our method easily models a large number of entity attributes triples. In order to prove the efficiency, we extract the attributive triples from FB24k dataset to build the evaluation dataset called FB15k-237-Attr.

FB24k FB24k is built based on Freebase dataset. FB24k only selects the entities and relations which appeared at least 30 triples. The number of entities is 23,634, and the number of relations is 673. In addition, the reversed relations are removed from original dataset. In FB24k datasets, the attributional triples are provided. FB24k contains 207,151 attributional triples and 314 attributes.

FB15k-237-Attr We extract the attributional triples of entities in FB15k-237 from FB24k. During the mapping, there are 7,589 nodes from original 14,541 entities which have the node attributes. Finally, we extract 78334 attributional triples from FB24k. These triples include 203 attributes and 247 relations. Based on these attributional triples, we create the FB15k-237-Attr dataset, which includes 14,541 entities nodes, 203 attributes nodes, 484 relations. All the 78334 attributional triples are combined with the train edges set from FB15k-237.

TABLE 2
Statistics of datasets.

| Dataset | FB15k-237 | WN18RR | FB15k-237-Attr |
|---|---|---|---|
| Entities | 14,541 | 40,943 | 14,744 |
| Relations | 237 | 11 | 484 |
| Train Edges | 272,115 | 86,835 | 350,449 |
| Val. Edges | 17,535 | 3,304 | 17,535 |
| Test Edges | 20,466 | 3,134 | 20,466 |
| Attributes Triples | — | — | 78,334 |
| Attributes | — | — | 203 |

The hyperparameters for our Conv-TransE, SACN model are determined by a grid search during the training. We manually specify the hyperparameters ranges: learning rate {0.01, 0.005, 0,003, 0,001}, dropout rate {0.0, 0.1, 0.2, 0.3, 0.4; 0.5}, embedding size {100, 200, 300}, number of kernels {50, 100, 200, 300}, and kernel size {1×2, 3×2, 5×2}. 3×2 kernel means we compute a convolution with a 1×3 kernel separately, and then weighted sum the 2 resulting vectors.

Here all the models use the two-layer WGCN. For different datasets, the combination hyperparameters settings to get the excellent performance are different. For FB15k-237, we set the dropout as 0.2, number of kernels as 100, learning rate as 0.003 and embedding size as 200 for SACN. If we run the Conv-TransE model, we decrease the embedding size as 100 and number of kernels as 50 and increase the dropout rate to 0.4. When we use the FB15k-237-Attr dataset, we increase the dropout rate to 0.3 and number of kernels to 300. For WN18RR dataset, the hyperparameters of dropout 0.2, number of kernels 300, learning rate 0.003 and embedding size as 200 for SACN work well. When using the Conv-TransE model, the same setting still works well.

Each data is split into three sets: training, validation, and testing, which is same with ConvE. We use the adaptive moment (Adam) algorithm for training the model. Our models are implemented by PyTorch and run on Red Hat Linux 4.8.5 system with NVIDIA Tesla P40 Graphics Processing Units (GPUs).

Evaluation protocol Our experiments use the proportion of correct entities ranked in top 1,3 and 10 (Hits@1, Hits@3, Hits@10) and the mean reciprocal rank (MRR) as the metrics. In addition, since some corrupted triples may exist in the knowledge graphs, we use the filtered setting, i.e., we filter out all valid triples before ranking.

Link Prediction Our results on the standard FB15k-237, WN18RR and FB15k-237-Attr are shown in Table 3. Table 3 reports Hits@10, Hits@3, Hits@1 and MRR results of four different baseline models and two our models on three knowledge graphs datasets. The FB15k-237-Attr dataset is used to prove the efficiency of node attributes. So we run our SACN in FB15k-237-Attr to compare the result of SACN on FB15k-237.

TABLE 3
Link prediction for FB15k-237, WN18RR and FB15k-237 Attr datasets.

| | FB15k-237 | | | | WN18RR | | | |
|---|---|---|---|---|---|---|---|---|
| | Hits | | | | Hits | | | |
| Model | @10 | @3 | @1 | MRR | @10 | @3 | @1 | MRR |
| DisMult | 0.42 | 0.26 | 0.16 | 0.24 | 0.49 | 0.44 | 0.39 | 0.43 |
| Complex | 0.43 | 0.28 | 0.16 | 0.25 | 0.51 | 0.46 | 0.41 | 0.44 |
| R-GCN | 0.42 | 0.26 | 0.15 | 0.25 | — | — | — | — |
| ConvE | 0.49 | 0.35 | 0.24 | 0.32 | 0.48 | 0.43 | 0.39 | 0.46 |
| Conv-TransE | 0.51 | 0.37 | 0.24 | 0.33 | 0.52 | 0.47 | 0.43 | 0.46 |
| SACN | 0.54 | 0.39 | 0.26 | 0.35 | 0.54 | 0.48 | 0.43 | 0.47 |
| SACN using | 0.55 | 0.40 | 0.27 | 0.36 | — | — | — | — |
| FB15k-237-Attr | | | | | | | | |
| Performance | 12.2% | 14.3% | 12.5% | 12.5% | 12.5% | 11.6% | 10.3% | 2.2% |
| improvement | | | | | | | | |

Note:
DisMult (Yang et al, 2014); ComplEx (Trouillon et al. 2016); R-GCN (Schlichtkrull et al. 2018), ConvE (Dettmers et al. 2017).

We first compare our Conv-TransE model with the four baseline models. ConvE has the best performance comparing all baselines. In FB15k-237 dataset, our Conv-TransE model improves upon ConvE's Hits@10 by a margin of 4.1% , and upon ConvE's Hits@3 by a margin of 5.7% for the test. In WN18RR dataset, Conv-TransE improves upon ConvE's Hits@10 by a margin of 8.3% , and upon ConvE's Hits@3 by a margin of 9.3% for the test. For these results, we conclude that Conv-TransE using neural network keeps the transitional characteristic between entities and relations and achieve better performance.

Second, the structure information is added into our SACN model. In Table 3, SACN also get the best performances in the test dataset comparing all baseline methods. In FB15k-237, comparing ConvE, our SACN model improves Hits@10 value by a margin of 10.2%, Hits@3 value by a margin of 11.4%, Hits@1 value by a margin of 8.3% and MRR value by a margin of 9.4% for the test. In WN18RR dataset, comparing ConvE, our SACN model improves Hits@10 value by a margin of 12.5%, Hits@3 value by a margin of 11.6%, Hits@1 value by a margin of 10.3% and MRR value by a margin of 2.2% for the test.

Third, we add node attributes into our SACN model, i.e., we use the FB15k-237-Attr to train our model. The performance is improved again. Our model using attributes improves upon ConvE's Hits@10 by a margin of 12.2% , Hits@3 by a margin of 14.3%, Hits@1 by a margin of 12.5% and MRR by a margin of 12.5%.

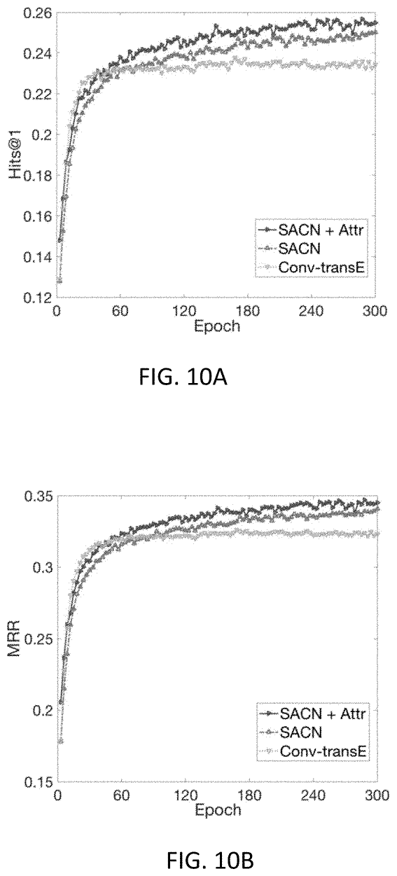

Convergence Analysis FIG. 10A and FIG. 10B show the convergence of “Conv-TransE”, “SACN” and “SACN+Attr” models. We can see the SACN (red line) is always better than Conv-TransE (yellow line) after several epochs. And the performance of SACN keeps increasing after around 120 epochs. However, the Conv-TransE has achieved the best performance around 120 epochs. The gap between these two models proves the useful of structure information. When using FB15k-237-Attr dataset, the performance of “SACN+Attr” is better than “SACN” model.

Kernel Size Analysis In Table 4, different kernel sizes are examined in our models. The kernel of “1×2” means the knowledge or information translating between one attribute of entity vector and the corresponding attribute of relation vector. If we increase the kernel size to “s×2” where s={1, 3, 5}, the information is translated between a combination of s attributes in entity vector and a combination of s attributes in relation vector. The larger view to collect attribute information can help to increase the performance as shown in Table 4. All the values of Hits@1, Hits@3, Hits@10 and MRR can be improved by increasing the kernel size in the FB15k-237 and FB15k-237-Attr datasets. However, the optimal kernel size may be task dependent.

TABLE 4
Kernel size analysis for FB15k-237 and FB15k-237-Attr datasets.
“SACN + Attr” means the SACN using FB15k-237-Attr dataset.

| | | FB15k-237 | | | |
|---|---|---|---|---|---|
| | | Hits | | | |
| Model | Kernel Size | @10 | @3 | @1 | MPR |
| Conv-TransE | 1 × 2 | 0.504 | 0.357 | 0.234 | 0.324 |
| Conv-TransE | 3 × 2 | 0.513 | 0.365 | 0.240 | 0.331 |
| Conv-TransE | 5 × 2 | 0.512 | 0.361 | 0.239 | 0.329 |
| SACN | 1 × 2 | 0.527 | 0.379 | 0.255 | 0.345 |
| SACN | 3 × 2 | 0.536 | 0.384 | 0.260 | 0.351 |
| SACN | 5 × 2 | 0.536 | 0.385 | 0.261 | 0.352 |
| SACN + Attr | 1 × 2 | 0.535 | 0.384 | 0.260 | 0.351 |
| SACN + Attr | 3 × 2 | 0.543 | 0.394 | 0.268 | 0.360 |
| SACN + Attr | 5 × 2 | 0.547 | 0.396 | 0.268 | 0.360 |

Node Indegree Analysis The indegree of the node in knowledge graph is the number of edges connected to the node. The node with larger degree means it has more neighboring nodes, and this kind of nodes can receive more information than other nodes with smaller degree. As shown in Table 5, we have different sets of nodes for different indegree scopes. The average Hits@10 and Hits@3 scores are calculated. Along the increasing of indegree scope, the average value of Hits@10 and Hits@3 will be increased. In addition, the node with small indegree will benefit from SACN model. For example, we can see the scope [1,100] of node indegree. The Hits@10 and Hits@3 of SACN are better than the Conv-TransE model. The reason is that the nodes of smaller indegree get the global information by WGCN, which leverages the knowledge graphs structure for node embeddings.

TABLE 5
Node indegree study using FB15k-237 dataset

| | |
|---|---|
| Conv-TransE | SACN |
| Average Hits | Average Hits |

| Indegree Scope | @10 | @3 | @10 | @3 |
|---|---|---|---|---|
| [0, 100] | 0.192 | 0.125 | 0.195 | 0.134 |
| [100, 200] | 0.441 | 0.245 | 0.441 | 0.253 |
| [200, 300] | 0.696 | 0.446 | 0.705 | 0.429 |
| [300, 400] | 0.829 | 0.558 | 0.806 | 0.577 |
| [400, 500] | 0.894 | 0.661 | 0.868 | 0.663 |
| [500, 1000] | 0.918 | 0.767 | 0.891 | 0.695 |
| [1000, maximum] | 0.992 | 0.941 | 0.981 | 0.922 |

We have introduced an end-to-end structure-aware convolutional network (SACN). The encoding network is a weighted graph convolutional network, utilizing knowledge graph connectivity structure, node attributes and relation types. WGCN with learnable weights has the benefit of collecting adaptive amount of information from neighboring graph nodes. In addition, the node attributes are added as the nodes of graph so that attributes are transformed into knowledge structure information, which is easily integrated into the node embedding. The scoring network of SACN is a convolutional neural model, called Conv-TransE. It uses the convolution network to model the relationship as translation operation and capture the transitional characteristic of between entities and relations. We also prove that Conv-TransE alone has already achieved the state of the art performance. The performance of SACN achieves about 10% improvement than the state of the art model such as ConvE.

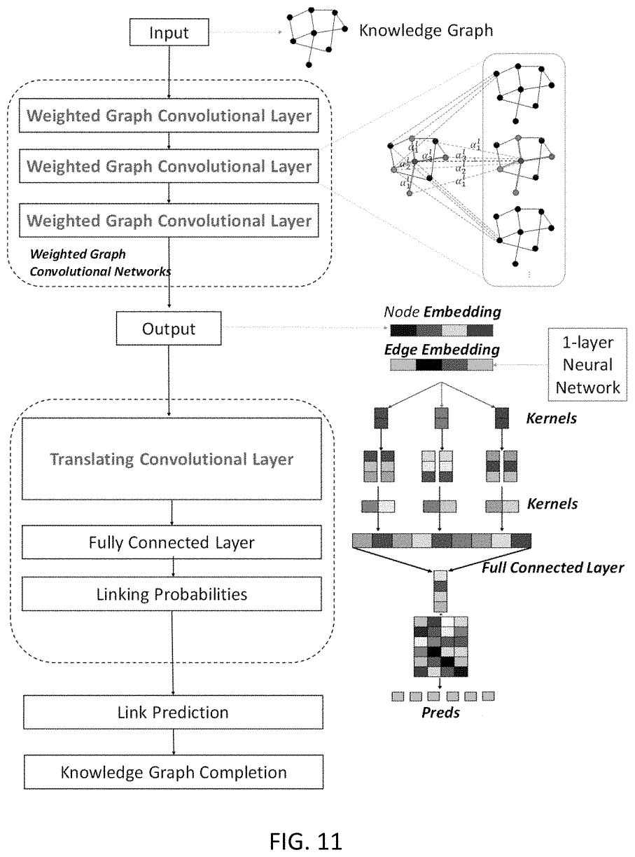

FIG. 11 is a summary of a workflow for knowledge graph completion according to certain embodiments of the present disclosure. As shown in FIG. 11, the SACN workflow includes a weighted graph convolutional network (WGCN) as an encoder and a Conv-TransE as a decoder. Raw graphs from a KG are used as input of the WGCN encoder. The raw graph may include graph adjacency matrices for different edge types and graph node feature matrix. The encoder may treat a multi-relational KB graph as multiple single-relational subgraphs; use the learnable weighted adjacency matrix to control the amount of information from neighboring nodes; and updata the node embedding based on the graph structure. By utilizing knowledge graph node structure, learning the interaction strength between two adjacent nodes by relation types, and utilizing attributes of graph nodes, the encoder obtains and outputs node embedding matrix.

Conv-TransE is used as an decoder. The decoder is a convolutional neural network model which is parameter-efficient, fast to compute. The decoder keeps the transitional characteristic between entities and relations. For example, the inputs for the decoder are the embedding of node “Statue of Liberty” and the embedding of edge “is located in”. The layer learns the several embeddings for (Statue of Liberty, is located in) and combines them to an embedding by fully connected layer. The neural network predicts the tail entity and outputs the probabilities of other nodes. If the node with highest probability is the “New York”, that means we predict the link (Statue of Liberty, is located in, New York) correctly.

The SACN model of the disclosure is an end-to-end neural network model to leverage the graph structure and preserve the translational property for the knowledge graph/base completion.

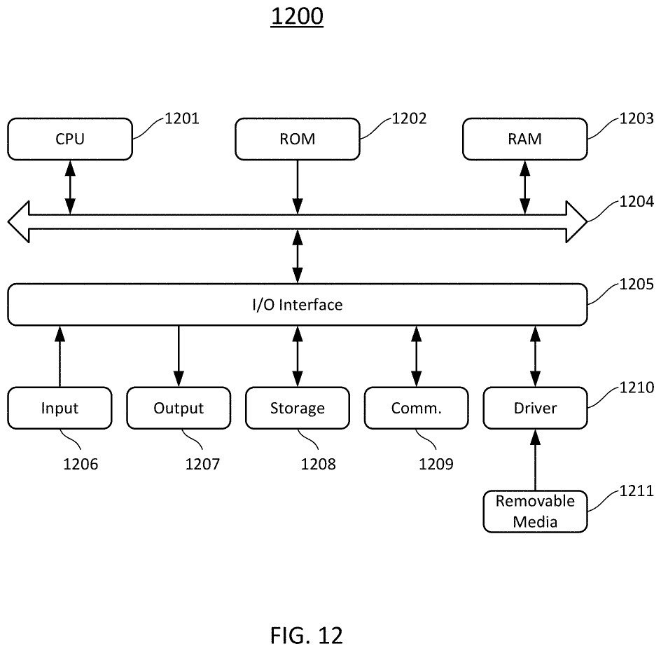

FIG. 12 schematically depicts a computing device according to certain embodiments of the present disclosure. As shown in FIG. 12, the computing device 1200 includes a Central Processing Unit (CPU) 1201. The CPU 1201 is configured to perform various actions and processes according toprograms stored in a Read Only Memory (ROM) 1202 or loaded into a Random Access Memory (RAM) 1203 from storage 1208. The RAM 1203 has various programs and data necessary for operations of the computing device 1200. The CPU 1201, the ROM 1202, and the RAM 1203 are interconnected with each other via a bus 1204. Further, an I/O interface 1205 is connected to the bus 1204.

In certain embodiments, the computing device 1200 further includes at least one or more of an input device 1206 such as keyboard or mouse, an output device 1207 such as Liquid Crystal Display (LCD), Light Emitting Diode (LED), Organic Light Emitting Diode (OLED) or speaker, the storage 1208 such as Hard Disk Drive (HDD), and a communication interface 1209 such as LAN card or modem, connected to the I/O interface 1205. The communication interface 1209 performs communication through a network such as Internet. In certain embodiments, a driver 1210 is also connected to the I/O interface 1205. A removable media 1211, such as HDD, optical disk or semiconductor memory, may be mounted on the driver 1210, so that programs stored thereon can be installed into the storage 1208.

In certain embodiments, the process flow described herein may be implemented in software. Such software may be downloaded from the network via the communication interface 1209 or read from the removable media 1211, and then installed in the computing device. The computing device 1200 will execute the process flow when running the software.

In a further aspect, the present disclosure is related to a non-transitory computer readable medium storing computer executable code. The code, when executed at one or more processer of the system, may perform the method as described above. In certain embodiments, the non-transitory computer readable medium may include, but not limited to, any physical or virtual storage media.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A method for knowledge base completion, the method comprising:
encoding a knowledge base comprising entities and relations between the entities into embeddings for the entities and embeddings for the relations, wherein the embeddings for the entities are encoded based on a Graph Convolutional Network (GCN) with different weights for at least some different types of the relations, which GCN is called a Weighted GCN (WGCN);
decoding the embeddings by a convolutional network for relation prediction, wherein the convolutional network is configured to apply one dimensional (1D) convolutional filters on the embeddings, which convolutional network is called Conv-TransE; and
at least partially completing the knowledge base based on the relation prediction.

2. The method of claim 1, further comprising adaptively learning the weights in the WGCN in a training process.

3. The method of claim 1, wherein at least some of the entities have respective attributes, and wherein the method further comprises processing, in the encoding, the attributes as nodes in the knowledge base like the entities.

4. The method of claim 1, wherein the embeddings for the relations are encoded based on a one-layer neural network.

5. The method of claim 1, wherein the respective embeddings for the relations have the same dimension as that of the respective embeddings for the entities.

6. The method of claim 1, wherein the Conv-TransE is configured to keep the transitional characteristic between the entities and the relations.

7. The method of claim 1, wherein the decoding comprises applying, with respect to one from the embeddings for the entities as a vector and one from the embeddings for the relations as a vector, a kernel separately on the one entity embedding and the one relation embedding for 1D convolution to result in two resultant vectors, and weighted summing up the two resultant vectors.

8. The method of claim 7, further comprising padding each of the vectors into a padded version, wherein the convolution is performed on the padded version of the vector.

9. The method of claim 7, further comprising adaptively learning the kernel in a training process.

10. A system for knowledge base completion, the system comprising a computing device, the computing device having a processor, a memory, and a storage device storing computer executable code, wherein the computer executable code comprises:
an encoder configured to encode a knowledge base comprising entities and relations between the entities into embeddings for the entities and embeddings for the relations, wherein the encoder is configured to encode the embeddings for the entities based on a Graph Convolutional Network (GCN) with different weights for at least some different types of the relations, which GCN is called a Weighted GCN (WGCN); and
a decoder configured to decode the embeddings by a convolutional network for relation prediction, wherein the convolutional network is configured to apply one dimensional (1D) convolutional filters on the embeddings, which convolutional network is called Conv-TransE,
wherein the processor is configured to at least partially complete the knowledge base based on the relation prediction.

11. The system of claim 10, the encoder is configured to adaptively learn the weights in the WGCN in a training process.

12. The system of claim 10, wherein at least some of the entities have respective attributes, and wherein the encoder is configured to process the attributes as nodes in the knowledge base like the entities.

13. The system of claim 10, wherein the encoder is configured to encode the embeddings for the relations based on a one-layer neural network.

14. The system of claim 10, wherein the encoder is configured to encode the respective embeddings for the relations and the respective embeddings for the entities to have the same dimension.

15. The system of claim 10, wherein the Conv-TransE is configured to keep the transitional characteristic between the entities and the relations.

16. The system of claim 10, wherein the decoder is configured to apply, with respect to one from the embeddings for the entities as a vector and one from the embeddings for the relations as a vector, a kernel separately on the one entity embedding and the one relation embedding for 1D convolution to result in two resultant vectors, and to weighted sum up the two resultant vectors.

17. The system of claim 16, wherein the decoder is further configured to pad each of the vectors into a padded version, wherein the convolution is performed on the padded version of the vector.

18. The system of claim 17, wherein the decoder is further configured to adaptively learn the kernel in a training process.

19. A non-transitory computer readable medium storing computer executable code, wherein the computer executable code is configured to perform the method of claim 1.
